(19) United States
(12) Patent Application Publication
(10) Pub. No.: US 2007/0101087 A1
(43) Pub. Date: May 3, 2007

(54) Memory module and memory device and method of operating a memory device

(76) Inventor: Peter Gregorius, Munchen (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/264,059

(22) Filed: Oct. 31, 2005

(51) Int. Cl. G06F 13/00

(52) U.S. Cl. 711/167

(57) ABSTRACT

A memory module is configured to be arranged in a series configuration of memory modules. The memory module includes a clock synthesizer unit configured to regenerating an input clock signal of the memory module and to produce a regenerated clock signal. A first receiver is configured to receive a command and write data signal from a memory controller or from another memory module located upstream in the series configuration. A first transmitter is configured to transmit a read data signal from the memory module to the memory controller or to a previous memory module of the series configuration and to synchronize the read data signal transmitted from the memory module to the regenerated clock signal of the memory module. A second receiver is configured to receive the read data signal from a next memory module of the series configuration. A second transmitter is configured to transmit the command and write data signal to other memory modules located downstream in the series configuration and to synchronize the command and write data signal transmitted from the memory module to the regenerated clock signal of the memory module.

### BACKGROUND

In present computer systems, memory devices for both reading and writing data, (e.g., memories designated as Random Access Memory (RAM), are typically realized on the basis of memory modules referred to as Double-Data Rate Type (DDR-type). These memory modules can be accessed in read and write operations at a very high speed, thereby offering a high data bandwidth. In these memory devices, the transfer of control and data signals between the memory modules of the memory device and a memory controller is synchronized on a system level to a reference clock provided by the memory controller. As a result, the data transfers of all memory modules have simultaneously to be synchronized to the same clock signal. For increasing memory speeds, (i.e., for higher frequencies of the clock signal), and larger numbers of memory modules, the difficulties in providing the data transfer between the memory controller and the memory modules increase, and eventually a reliable data transfer becomes impossible.

In view of these problems, there has been proposed a new type of architecture for memory devices, which is referred to as star-type. Here, a plurality of memory modules are connected in a series configuration to the memory controller. A command and address signal and/or a write data signal is received from the memory controller in a first memory module of the series configuration. From the first memory module of the series configuration, the command and address signal and/or the write data signal is forwarded to other memory modules of the memory device. A read data signal is transmitted from one of the memory modules of the series configuration back to a previous memory module of the series configuration until the read data signal is received in the first memory module of the series configuration. From the first memory module of the series configuration, the read data signal is transmitted to the memory controller.

The structure of a memory device 100′ corresponding to the star-type architecture is illustrated in FIG. 1. As illustrated, the memory device 100′ comprises a plurality of memory modules 100a′, 100b′, 100c′, and 100d′ having a substantially identical configuration. The memory device 100′ is connected to a memory controller 200′. The memory controller 200′ provides for the connection to components of a computer system, such as a central processing unit and other devices connected to a system bus (not illustrated).

The memory controller 200′ provides a command and address signal CA and a write data signal WD to the memory device 100′. The command and address signal CA and the write data signal WD are transmitted via a digital bus having a suitable width for carrying said signals. In the following, the command and address signal CA and the write data signal WD are referred to in combination as command and write data signal CA, WD. Further, the memory controller 200′ supplies a clock signal CLK to the memory device 100′. The memory controller 200′ receives from the memory device 100′ a read data signal RD and a related clock signal TxPCK.

Each of the memory modules 100a′, 100b′, 100c′, 100d′ comprises a memory core 110′ and a core interface 120′. Via the core interface 120′ the memory core 110′ is connected to circuitry for receiving and transmitting data.

The circuitry for receiving and transmitting data comprises for each of the memory modules 100a′, 100b′, 100c′, 100d′ a primary receiver RxP for receiving the command and write data signal CR, WD in the memory module 100a′, 100b′, 100c′, 100d′ and a primary transmitter TxP for transmitting the read data signal RD from the memory module 100a′, 100b′, 100c′, 100d′. Further, each of the memory modules 100a′, 100b′, 100c′, 100d′ comprises a secondary transmitter TxS for transmitting the command and write data signal CA, WD from the memory module 100a′, 100b′, 100c′, 100d′ and a secondary receiver RxS for receiving the read data signal RD in the memory module 100a′, 100b′, 100c′, 100d′. The primary receiver RxP, the secondary receiver RxS, the primary transmitter TxP, and the secondary transmitter TxS allow for arranging the memory modules 100a′, 100b′, 100c′, 100d′ in a series configuration as illustrated in FIG. 1. Each of the primary and secondary receivers RxP, RxS and the primary and secondary transmitters TxP, TxS is configured to synchronize the received or transmitted signal to a respective input clock signal, thereby allowing for a transfer of the command and write data signal CA, WD and of the read data signal RD between different clock domains.

In the following, the distribution of the command and write data signal CA, WD, of the read data signal RD and of clock signals according to the star-type architecture is described.

In a first memory module 100a′ of the memory device 100′, the command and write data signal CA, WD is received from the memory controller 200′. The command and write data signal CA, WD is received via the primary receiver RxP. The clock signal CLK provided by the memory controller 200′ is used as the input clock signal of the primary receiver RxP. The same clock signal is also used as the input clock signal of the primary transmitter TxP and the secondary transmitter TxS.

Further, the clock signal CLK provided by the memory controller 200′ is fed into a delay-locked loop (DLL) 150′ of the memory module 100a′. The DLL 150′ generates from its input clock signal a delayed clock signal which is used for controlling read and write operations of the memory core 110′ via the core interface 120′.

The input clock signal of the primary transmitter is forwarded to a corresponding signal output of the first memory module 100a′ and then transmitted to the memory controller 200′ as the related clock signal TxPCK of the read data signal RD transmitted from the memory module 100a′ to the memory controller 200′. The input clock signal of the secondary transmitter TxS is forwarded to a respective signal output of the first memory module 100a′ and from there to a second memory module 100b′ of the series configuration. Further, also the input clock signal of the DLL 150′ is forwarded to a corresponding signal output of the first memory module 100a′ and from there to the second memory module 100b′.

Via the secondary transmitter TxS, the command and write data signal CA, WD is transmitted from the first memory module 100a′ to the other memory modules 100b′, 100c′, 100d′ of the memory device 100′. Thus, the command and write data signal CA, WD is distributed within the memory device 100′ in a star-type fashion. Clock signals and the read data signal RD are, however, transmitted between the memory modules 100a′, 100b′, 100c′, 100d′ in a serial fashion, (i.e., downstream from one memory module to the next memory module of the series configuration or upstream from one memory module to the previous memory module of the series configuration).

Specifically, the second memory module 100b′ receives at corresponding signal inputs the input clock signal of the DLL 150′ of the first memory module 100a′, (i.e., the clock signal. CLK provided by the memory controller 200′), and the input clock signal of the secondary transmitter TxS of the first memory module 100a′.

In the second memory module 100b′ it is possible to select via a multiplexer 140′, which of the received clock signals is used as the input clock signal of the DLL 150′ of the second memory module 100b′. Generally, all these clock signals have been derived from the clock signal CLK provided by the memory controller 200′, but have been transmitted via different signal paths and therefore the signal quality may be different.

In the second memory module 100b′, the input clock signal of the secondary transmitter of the first memory module 100a′ which is received from the first memory module 100a′, is used as the input clock signal of the primary receiver RxP, of the primary transmitter TxP and of the secondary transmitter TxS. The input clock signal of the secondary transmitter TxS of the second memory module 100b′ is forwarded to a respective signal output of the second memory module 100b′ and from there to the third memory module 100c′. In the third memory module 100c′ this input clock signal received from the second memory module is again used as the input clock signal of the primary receiver RxP, of the primary transmitter TxP, and of the secondary transmitter TxS. The input clock signal of the secondary transmitter TxS of the third memory module is forwarded to a respective signal output of the third memory module 100c′ and from there to the fourth memory module 100d′. In the fourth memory module 100d′, this input clock signal received from the third memory module 100c′ is used as the input clock signal of the primary receiver RxP, of the primary transmitter TxP, and of the secondary transmitter TxS. In this way, a clock signal related to the command and write data signal CA, WD is forwarded from one memory module to the next memory module of the series configuration.

Further, the input clock signal of the DLL 150′ of the first memory module 100a′ which is forwarded from the first memory module 100a′ to the second memory module 100b′ is also directly forwarded to the third memory module 100c′ and to the fourth memory module 100d′; where it is received at a corresponding signal input. In the third memory module 100c′ and in the fourth memory module 100d′ it can be selected via the multiplexer 140′, which of the input clock signals of the memory module 100c′, 100d′ is used as the input clock signal of the DLL 150′, (i.e., the input clock signal received from the previous memory module of the series configuration or the input clock signal received from the first memory module 100a′).

The read data signal RD is transmitted from one memory module to another memory module of the series configuration as well, but in an opposite direction, (i.e. in the upstream direction). As illustrated in FIG. 1, the read data signal RD is transmitted via the primary transmitter TxP from the fourth memory module 100d′ back to the third memory module 100c′, where it is received via the secondary receiver RxS. From the third memory module 100c′, the read data signal RD is transmitted via the primary transmitter TxP to the second memory module 100b′, where it is received via the secondary receiver RxS. From the second memory module 100b′, the read data signal RD is transmitted via the primary transmitter TxP to the first memory module 100a′, where it is received via the secondary receiver RxS. As already mentioned above, the read data signal RD is transmitted via the primary transmitter TxP from the first memory module 100a′ to the memory controller 200′. Accordingly, the read data RD is transmitted from one memory module to the previous memory module until it is received in the first memory module 100a′ and then transmitted to the memory controller 200′. In parallel to the read data signal RD, the related clock signal TxPCK, (i.e., the input clock signal of the primary transmitter TxP) is transmitted from one memory module to the previous memory module, where it is used as the input clock signal of the secondary receiver RxS.

As illustrated, the memory modules 100a′, 100b′, 100c′, 100d′ generally have the same structure, and the internal signal processing is accomplished in the same way.

An advantage of this star-type architecture is that a reduced latency is obtained with respect to transmitting the command and write data signal CA, WD to the memory modules. This specifically applies to the memory modules which are located farther away from the memory controller 200′, (i.e., to the third memory module 100c′ and to the fourth memory module 100d′).

However, in the memory device as illustrated in FIG. 1 there exist problems as to the quality of the input signals received by the memory modules 100a′, 100b′, 100c′, 100d′ and by the memory controller 200′. In particular, before reaching the fourth memory module 100d′, the clock signal CLK provided by the memory controller 200′ has passed through all the other memory modules 100a′, 100b′, and 100c′ or has been transmitted over long distances within the memory device 100′. Moreover, the clock signal CLK provided by the memory controller 200′ may already have undergone a substantial degradation when it is received from the memory controller 200′ in the first memory module 100a′, thereby adversely affecting the transmission of the command and write data signal CA, WD from the first memory module 100a′ to the other memory modules 100b′, 100c′, 100d′. In the same way, problems arise as to the transmission of the read data signal RD from one memory module to the previous memory module of the series configuration, specifically if the read data signal RD is transmitted from a memory module located farther away from the memory controller 200′. As a result, it will generally be difficult or even impossible to receive the read data signal RD in the memory controller 200′ at a desirable speed, (i.e., to use a high frequency for the clock signal CLK).

Therefore, there exists a need for improvements of a memory device having the above-mentioned star-type architecture.

### SUMMARY

One aspect of the present invention provides a memory module configured to be arranged in a series configuration of memory modules. The memory module includes a clock synthesizer unit, a first receiver, a first transmitter, a second receiver, and a second transmitter. The clock synthesizer unit is configured to regenerating an input clock signal of the memory module and to produce a regenerated clock signal. The first receiver is configured to receive a command and write data signal from a memory controller or from another memory module located upstream in the series configuration. The first transmitter is configured to transmit a read data signal from the memory module to the memory controller or to a previous memory module of the series configuration and to synchronize the read data signal transmitted from the memory module to the regenerated clock signal of the memory module. The second receiver is configured to receive the read data signal from a next memory module of the series configuration. The second transmitter is configured to transmit the command and write data signal to other memory modules located downstream in the series configuration and to synchronize the command and write data signal transmitted from the memory module to the regenerated clock signal of the memory module.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 schematically illustrates a conventional memory device.

FIG. 2 schematically illustrates a memory device according to one exemplary embodiment.

FIG. 3 schematically illustrates an embodiment of the memory device of FIG. 1 with a modified clocking arrangement.

FIG. 4 schematically illustrates a memory device according to another exemplary embodiment.

FIG. 5 schematically illustrates a memory device according to another exemplary embodiment.

FIG. 6 schematically illustrates a memory device according to another exemplary embodiment.

FIG. 7 schematically illustrates an embodiment of the memory device of FIG. 6 with a modified clocking arrangement.

FIG. 8 schematically illustrates an embodiment of a fully digitally implemented phase-locked loop to be used in a memory module according to an embodiment of the invention.

FIG. 9 schematically illustrates a further embodiment of a fully digitally phase-locked loop.

FIG. 10 schematically illustrates an embodiment of a digitally controlled oscillator to be used in the phase-locked loop according to FIGS. 8 or 9.

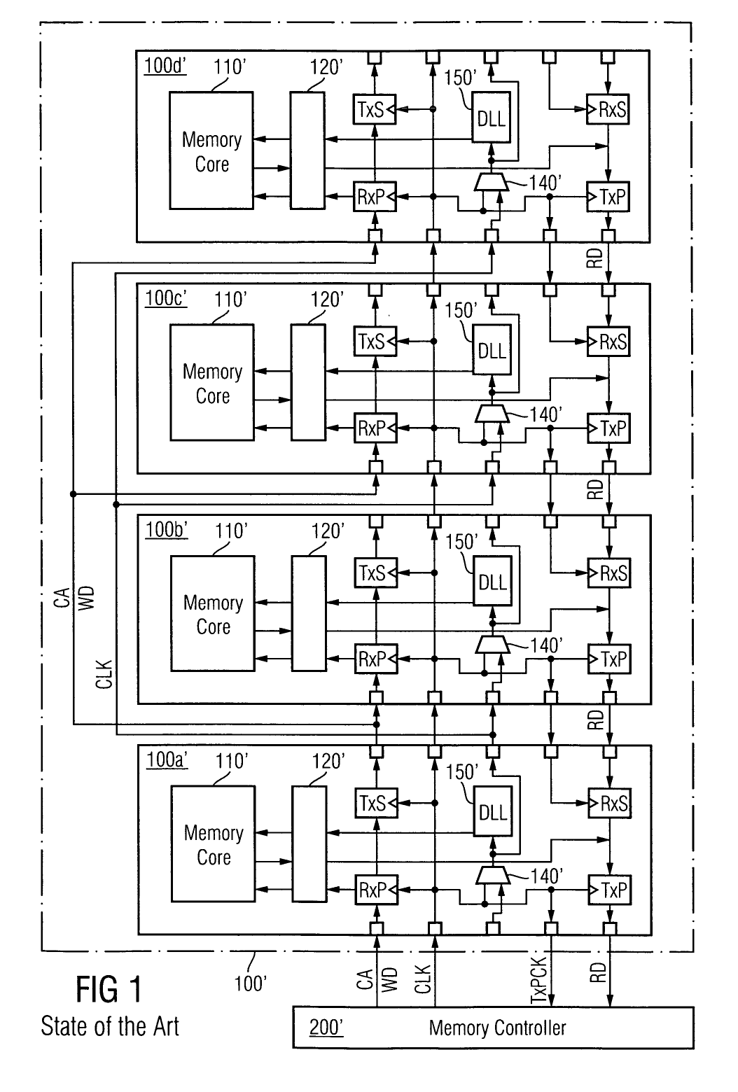

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments relate to a method of operating a memory device having a star-type architecture, to a corresponding memory device and to a memory module to be used in such a memory device. In particular, some embodiments relate to the distribution and transfer of control, data, and clock signals in such a memory device.

One embodiment provides for transmitting at least the read data signal from one memory module to a previous memory module of a series configuration or to the memory controller of a memory device on the basis of a high-quality clock signal, thereby allowing for the memory device to be operated within increased data rate.

An embodiment of a method of operating a memory device includes a plurality of memory modules arranged in a series configuration. The method includes receiving a command and write data signal from a memory controller in a first memory module of the series configuration, transmitting the command and write data signal from the first memory module of the series configuration to other memory modules of the series configuration, transmitting a read data signal from one of the memory modules of a series configuration to a previous memory module of a series configuration until the read data signal is received in the first memory module of the series configuration, and transmitting the read data signal from the first memory module of the series configuration to a memory controller.

Further, in one embodiment, the method includes receiving an input clock signal in each of the memory modules, regenerating the input clock signal in a respective clock synthesizer unit of the memory module so as to produce a regenerated clock signal of the memory module, and synchronizing the read data signal transmitted from the memory module to the respective regenerated clock signal of the memory module. In one embodiment, the method also comprises synchronizing the command and write data signal transmitted from the first memory module to the regenerated clock signal of the first memory module.

For regenerating the input clock signal of the memory module, the clock synthesizer unit of the memory module can comprise a phase-locked loop which receives the input clock signal and produces as an output signal the regenerated clock signal. The clock synthesizer unit can also be used to provide a clock signal for controlling a memory core of the memory module, this clock signal being delayed or phase-shifted with respect to the input clock signal of a clock synthesizer unit. In this way, the clock synthesizer unit simultaneously accomplishes the function of a clock signal delaying means or a clock signal phase adjustment means, which conventionally as described above is accomplished by the DLL. Additionally or as an alternative to the phase-locked loop, the clock synthesizer unit may also comprise a DLL which is used to receive the input clock signal of the memory module and to produce as an output signal the regenerated clock signal.

In one embodiment, the method also comprises generating the input clock signal of the memory modules by means of a phase-locked loop. In this way, the input clock signal of the memory modules may already be provided with a higher quality and the requirements with respect to regenerating the input clock signal in the clock synthesizer unit of the memory module may be relaxed.

In one embodiment, the phase-locked loop for providing the input clock signal of the memory module and/or the phase-locked loop of the clock synthesizer unit is digitally implemented.

It is to be understood that forwarding the read data signal from one memory module to the previous memory module of the series configuration may either comprise generating the read data signal in the memory module according to data stored in a memory core of the memory module and transmitting the read data signal from the memory module, or receiving the read data signal in the memory module from the next memory module of the series configuration and transmitting the read data signal from the memory module, depending on the particular type of operation initiated by the command and write data signal, (e.g., a read operation on a memory module located downstream from the memory module with respect to the direction of transfer of the read data signal, a read operation on the same memory module, or a write operation).

According to another embodiment, a memory device comprises a plurality of memory modules arranged in a series configuration. In the memory device, each of the memory modules comprises a clock synthesizer unit for regenerating an input clock signal of the memory module, and producing a regenerated clock signal, a first receiver for receiving a command and write data signal in a memory module, and a first transmitter for transmitting the read data signal from the memory module. The first transmitter is configured to synchronize the read data signal transmitted from the memory module to the regenerated input clock signal of the memory module. Further, in each of the memory modules a second receiver is provided for receiving the read data signal from a next memory module of the series configuration. At least a first memory module of the memory device comprises a second transmitter for transmitting the command and write data signal to other memory modules of a series configuration. The second transmitter is configured to synchronize a read data signal transmitted from the memory module to the regenerated input clock signal of the memory module.

The architecture of the memory device according to this embodiment generally corresponds to the above-mentioned star-type architecture, (i.e., the command and write data signal is transmitted in a downstream direction from the first memory module of the series configuration to other memory modules of the series configuration in a star-type fashion, and the read data signal is transmitted in an upstream direction from one memory module of the series configuration to a previous memory module of the series configuration until the first memory module of the series configuration is reached). From the first memory module of the series configuration, the read data signal can be transmitted to a memory controller which also provides the command and write data signal to the first memory module of a series configuration.

The clock synthesizer unit in the memory modules can comprise a phase-locked loop. In particular, the phase-locked loop may be digitally implemented.

As described herein, the digitally implemented phase-locked loop can comprise a phase detector configured to generate a digital phase difference signal depending on the input clock signal and a feedback clock signal, a digital filter configured to receive the phase difference signal and to generate a digital filtered phase difference signal, and a digitally controlled oscillator which is controlled in response to the filtered phase difference filter. In one embodiment, the phase-locked loop also comprises a digital frequency difference detector which receives the input clock signal and the feedback clock signal and produces a digital frequency difference signal.

In addition to regenerating the input clock signal of the memory module, the clock synthesizer unit can also be configured to provide a clock signal to a memory core of the memory module with a suitably adjusted and controlled delay or phase shift with respect to the input clock signal of the memory module. This can achieve the desired phase relations between control signals for performing read and write operations on the memory core.

In the above-mentioned memory device embodiment, the clock synthesizer units may be configured in such a manner that the clock synthesizer unit of one memory module of the series configuration provides the input clock signal to the clock synthesizer unit of the next memory module of the series configuration. In this respect, in one embodiment not more than three of the clock synthesizer units are connected in series.

According to another embodiment, a memory module is configured to be used in the memory device as described above. In one embodiment, the memory module comprises a clock synthesizer unit for regenerating an input clock signal of the memory module and producing a regenerated clock signal of the memory module, a first receiver for receiving a command and write data signal from a memory controller or from another memory module located upstream in a series configuration and a first transmitter for transmitting a read data signal from the memory module to the memory controller or to a previous memory module of the series configuration. The memory module further comprises a second receiver for receiving the read data signal from a next memory module of the series configuration and a second transmitter for transmitting the command and write data signal to other memory modules located downstream in the series configuration. The first transmitter is configured to synchronize the read data signal transmitted from the memory module to the regenerated clock signal, and the second transmitter is configured to synchronize the command and write data signal transmitted from the memory module to the regenerated clock signal.

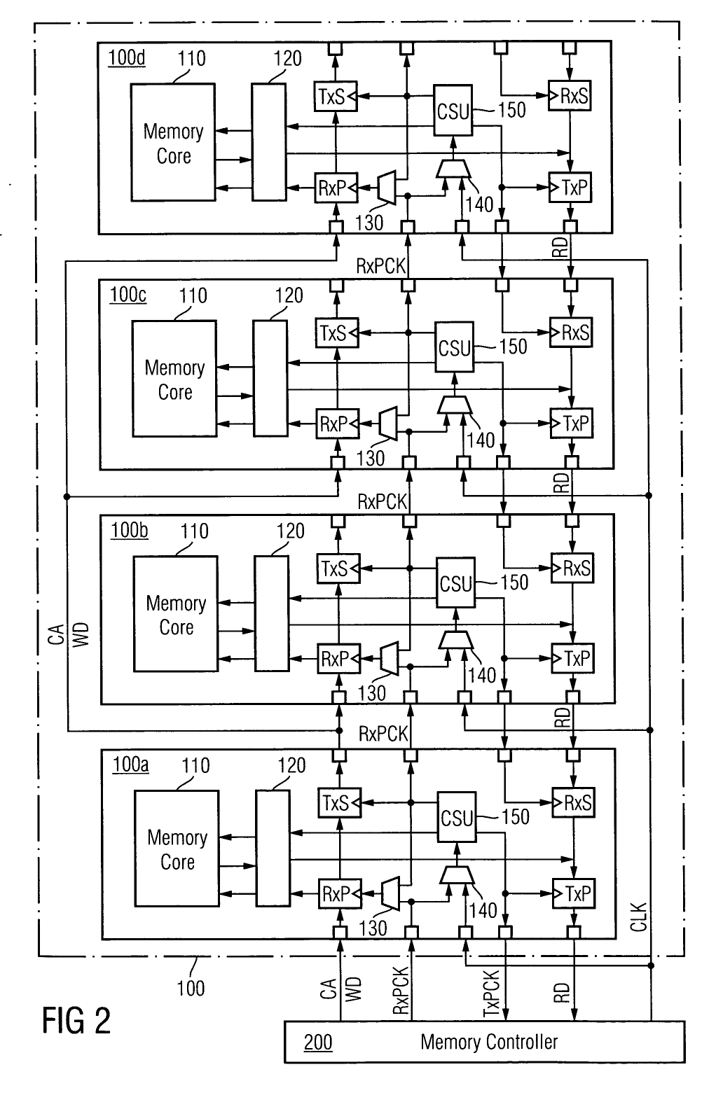

FIG. 2 illustrates one embodiment of a memory device 100 comprising a plurality of memory modules 100a, 100b, 100c, 100d which are connected in a series configuration corresponding to the star-type architecture. A memory controller 200 is provided for connecting the memory device 100 to other components of a computer system such as a central processing unit and other devices connected to a system bus (not illustrated). The memory controller 200 supplies a command and address signal CA, a write data signal WD, and a clock signal CLK to the memory device 100. The memory controller 200 receives from the memory device 100 a read data signal RD and a related clock signal TxPCK. The command and address signal CA and the write data signal WD are transmitted via a common digital bus. Therefore, in the following these signals are referred to as command and write data signal CA, WD.

In one embodiment, each of the memory modules 100a, 100b, 100c, 100d comprises a dynamic random access memory (DRAM) memory core 110, a core interface 120 and circuitry for the transfer of the signals. The core interface 120 serves for connecting the memory core 110 to the circuitry for the transfer of signals and for controlling the memory core 110. The core interface 120 may actually have further signal connections to the memory core 110 and to the circuitry for the transfer of signals which, for the sake of clarity, have not been illustrated in FIG. 2.

In each of the memory modules, the circuitry for the transfer of signals comprises a first or primary receiver RxP for receiving the command and write data signal CA, WD in the memory module 100a, 100b, 100c, 100d and a first or primary transmitter TxP for transmitting a read data signal RD from the memory module 100a, 100b, 100c, 100d. In addition, a second or secondary receiver RxS is provided for receiving a read data signal RD in the memory module 100a, 100b, 100c, 100d, and a second or secondary transmitter TxS is provided for transmitting the command and write data signal from the memory module 100a, 100b, 100c, 100d.

Each of the primary receiver and transmitter RxP, TxP and the secondary receiver and transmitter RxS, TxS is configured to synchronize the received or transmitted signal to a respective input clock signal.

Further, each of the memory modules comprises a clock synthesizer unit (CSU) 150 for receiving an input clock signal of the memory module 100a, 100b, 100c, 100d and producing as an output signal a regenerated clock signal. The regenerated clock signal has a predefined phase relation to the input clock signal and the same frequency. However, in the regenerated clock signal, damping, distortions and jitter of the input clock signal are compensated for. This can accomplished by means of a phase-locked loop (PLL) of the CSU 150, as is described below in more detail.

In the memory device 100 of FIG. 2, the memory modules 100a, 100b, 100c, 100d are arranged in a series configuration corresponding to the star-type architecture. The first memory module 100a of the series configuration receives the command and write date signal CA, WD and the clock signal CLK provided by the memory controller 200. The primary receiver RxP synchronizes the received command and write data signal CA, WD to the clock signal CLK. This purpose, the clock signal CLK provided by the memory controller is used as the input clock signal of the primary receiver RxP. In the memory module 100a the received command and write data signal CA, WD is forwarded to the secondary transmitter TxS to be further transmitted to the other memory modules 100b, 100c, 100d of the series configuration. Further, in a read operation, the first memory module 100a may generate the read data signal Rd according to data stored in the memory core 110 of the first memory module 100a. The read data signal RD is then transmitted to the memory controller 200 via the primary transmitter TxP of the first memory module 100a.

The primary transmitter TxP and the secondary transmitter TxS of the first memory module 100a receive as their input clock signal the regenerated input clock signal provided by the CSU 150 of the memory module 100a. Therefore, the transmission of the command and write data signal CA, WD from the first memory module 100a to the other memory modules 100b, 100c, 100d is accomplished on the basis of a high-quality clock signal. Similarly, the transmission of the read data signal RD from the first memory module 100a to the memory controller 200 is accomplished on the basis of a high-quality clock signal.

The input clock signal of the primary transmitter TxP is forwarded to a corresponding signal output of the first memory module 100a, from where it is transmitted as the related clock signal of the read data signal RD to the memory controller. The input clock signal of the secondary transmitter TxS is forwarded to a corresponding signal output of the first memory module 100a, from where it is supplied as a related clock signal of the command and write data signal CA, WD to the second memory module 100b of the series configuration. In the embodiment illustrated in FIG. 2, the related clock signal of the command and write data signal CA, WD transmitted between the memory controller 200 and the first memory module 100a is designated by RxPCK. The related clock signal of the read data signal RD transmitted between the first memory module 100a and the memory controller is designated by TxPCK. The related clock signal RxPCK of the command and write data signal CA, WD is also supplied from the memory controller to the memory module 100a. In the first memory module 100a, the input clock signal of the CSU 150 can be selected via a multiplexer 140 from the related clock signal RxPCK of the command and write data signal CA, WD and the clock signal CLK supplied by the memory controller 200. Via a multiplexer 130, the input clock signal of the primary receiver RxP can be selected from the related clock signal RxPCK of the command and write data signal CA, WD and the regenerated clock signal supplied by the CSU 150.

Further, the first memory module 100a is configured to receive the read data signal RD from the next memory module of the series configuration, (i.e., from the second memory module 100b), via the secondary receiver RxS. Together with the read data signal RD, the first memory module 100a receives the related clock signal of the read data signal RD from the second memory module 100b. The related clock signal of the read data signal RD received from the second memory module 100b is used as the input clock signal of the secondary receiver RxS.

As illustrated in FIG. 2, the second memory module 100b, the third memory module 100c, and the fourth memory module 100d have the same structure as the first memory module 100a. However, the input signals of these memory modules are generally received from different sources and the output signals of these memory modules are transmitted to different destinations. In each of the second memory module 100b, the third memory module 100c, and the fourth memory module 100d, the command and write data signal CA, WD is received via the primary receiver RxP from the first memory module 100a. Accordingly, the command and write data signal CA, WD is distributed from the first memory module 100a to the other memory modules 100b, 100c, 100d of the series configuration in a star-type fashion. By this means, a short latency when accessing the third memory module 100c and the fourth memory module 100d via the command and write data signal CA, WD is obtained. Further, each of the memory modules 100b, 100c, 100d receives the clock signal CLK supplied by the memory controller 200.

The related clock signal of the command and write data signal CA, WD is supplied from one memory module to the next memory module of the series configuration, (i.e., the second memory module 100b receives the related clock signal of the command and write data signal CA, WD from the first memory module 100a, the third memory module 100c receives the related clock signal of the command and write data signal CA, WD from the second memory module 100b, and the fourth memory module 100d receives the related clock signal of the command and write data signal CA, WD from the third memory module 100c). In each case, the related clock signal of the command and write data signal CA, WD received in the memory module is formed by the input clock signal of the secondary transmitter TxS of the previous memory module in the series configuration. Consequently, the related clock signal of the command and write data signal CA, WD is produced by the CSU 150 of the previous memory module and thus has a high signal quality.

The read data signal RD is transmitted from one memory module to the previous memory module of the series configuration, (i.e., the third memory module 100c receives a read data signal RD from the fourth memory module the second memory module receives the read data signal RD from the third memory module 100c, and, as already mentioned, the first memory module 100a receives the read data signal RD from the second memory module 100b). In each case, the data transfer is accomplished in the same manner as described for the first memory module 100a and the second memory module 100b.

As described herein, the command and write data signal CA, WD is transmitted through the memory device 100 in a downstream direction and the read data signal RD is transmitted in an upstream direction.

The selection of the input clock signals for the primary receiver RxP and for the CSU 150 via the multiplexers 130 and 140, respectively, can be accomplished on the basis of the quality of the received clock signals. For example, the related clock signal of the command and write data signal CA, WD received in the third memory module 100c is generated by the CSU 150 of the second memory module 100b and may therefore have a higher signal quality than the clock signal CLK supplied by the memory controller 200, which has traveled a larger distance.

As illustrated, all the memory modules 100a, 100b, 100c, 100d have the same configuration. This has the advantage that the memory modules are not limited to a specific position in the series configuration. However, this is not necessary to obtain the above-mentioned functionalities. For example, the secondary transmitter TxS is not necessarily required in the second memory module 100b, the third memory module 100c, and the fourth memory module 100d. Further, the secondary receiver RxS is not required in the fourth memory module.

As to the transfer of the read data signal RD, the data transfer in the memory device 100 is essentially based on point-to-point connections. In contrast, the transfer of the command and write data signal CA, WD is based on a point-to-multipoint-connection between the first memory module 100a and the other memory modules 100b, 100c, 100d. In this way, the latency with respect to accessing the third memory module 100c and the fourth memory module 100d via the command and write data signal CA, WD is reduced as compared to the case in which the command and write data signal CA, WD is transferred from one memory module to the next memory module of the series configuration. However, transmitting the command and write data signal CA, WD in the star-type fashion as illustrated requires that the transmitted signals have a higher quality. According to the arrangement of the embodiment of FIG. 2, this is accomplished by means of the CSU 150 in each of the memory modules 100a, 100b, 100c, 100d, which allows for transmitting the command and write data signal CA, WD and the read data signal RD on the basis of a high-quality clock signal. By means of the CSU 150, a degradation of the clock signals used for transmitting the signals from the memory modules 100a, 100b, 100c, 100d as compared to the clock signal CLK supplied by the memory controller 200 is compensated for.

In the clocking arrangement of the embodiment illustrated in FIG. 2, the clock signal CLK provided by the memory controller is distributed to each of the memory modules 100a, 100b, 100c, 100d. Therefore, the arrangement as illustrated in FIG. 2 may be regarded as a source synchronous system in which the memory controller 200 is both the source of the command and write data signal CA, WD and of the clock signal CLK.

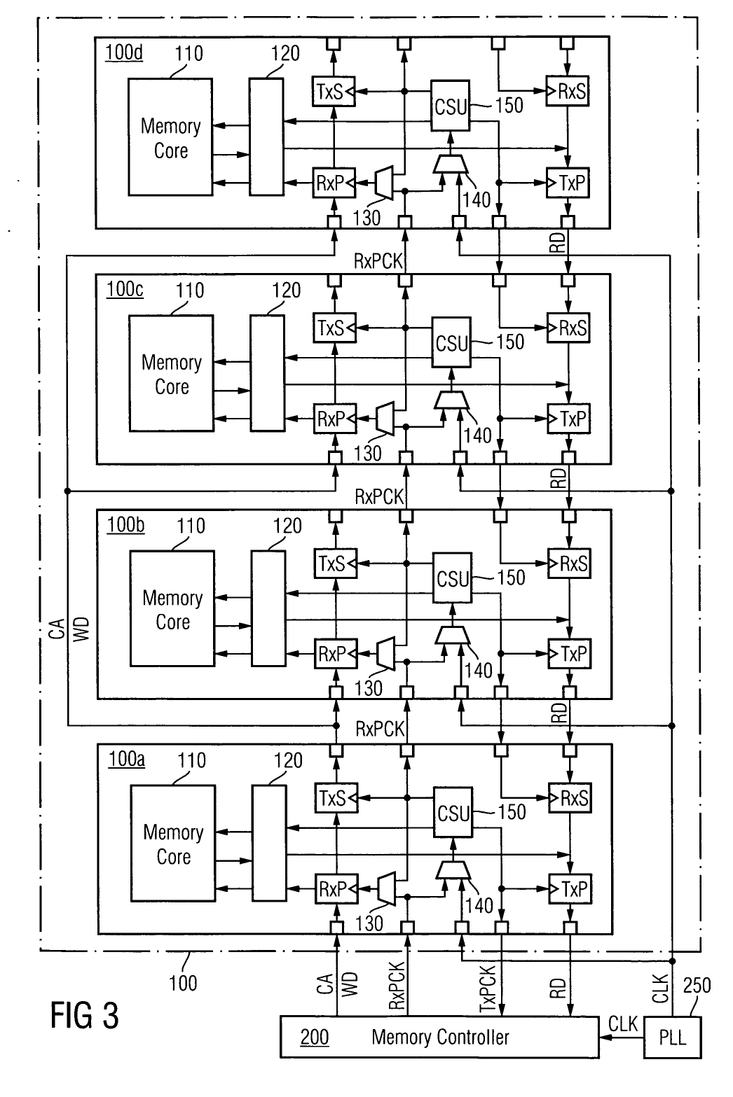

FIG. 3 illustrates an embodiment of the memory device 100 with a modified clocking arrangement. Generally, the arrangement as illustrated in FIG. 3 corresponds to that of FIG. 2. Components illustrated in FIG. 3 which correspond to that of FIG. 2 are designated with the same reference signs and in the following a more detailed description thereof will be omitted.

As compared to the clocking arrangement illustrated in FIG. 2, in the arrangement of FIG. 3 the clock signal CLK is provided to the memory device 100 from a PLL 250 which is arranged externally with respect to the memory controller 200. Further, the PLL 250 supplies the clock signal CLK to the memory controller 200. This allows for synchronizing internal clock signals of the memory controller 200 to the clock signal CLK. In particular, the command and write data signal CA, WD which is transmitted from the memory controller 200 to the memory device 100 and its related clock signal RxPCK are generated on the basis of the clock signal CLK supplied by the PLL 250.

The PLL 250 may be a separate component which is provided on the main board of a computer system and is in one embodiment fully digitally implemented so as to provide the clock signal CLK with a high quality and without requiring excessive outlay. The clocking arrangement as illustrated in FIG. 3 is also referred to as a mesosynchronous system.

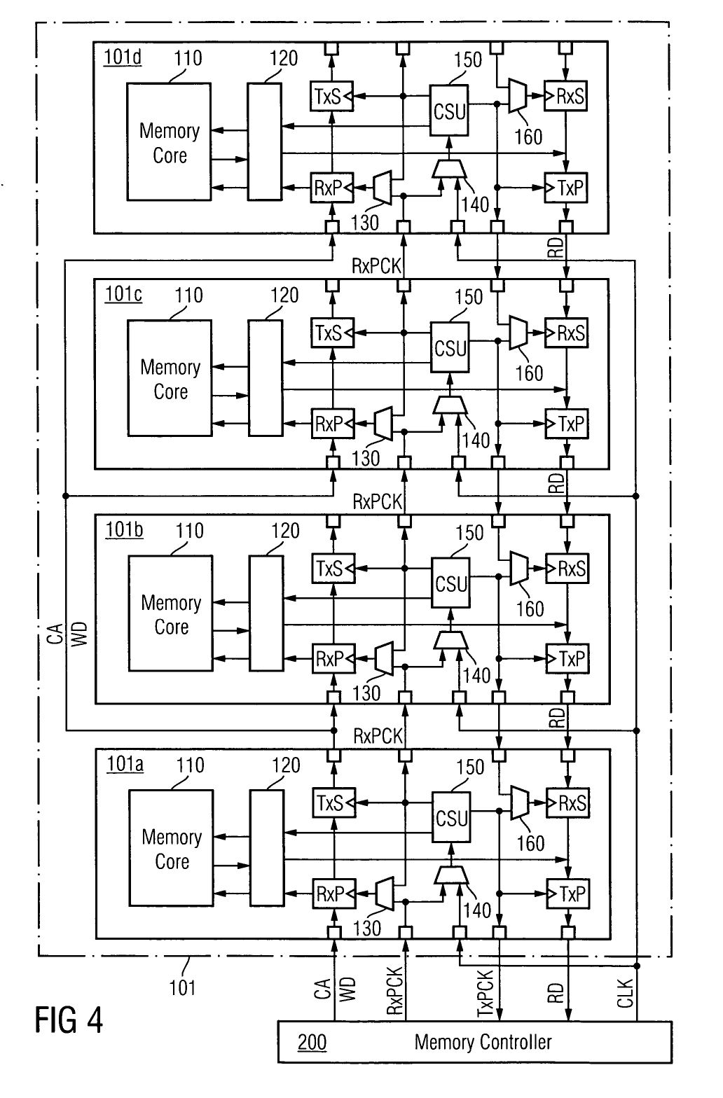

FIG. 4 illustrates one embodiment of a memory device 101 in which memory modules 101a, 101b, 101c, and 101d are arranged according to a series configuration corresponding to the star-type architecture. The memory modules 101a, 101b, 101c, and 101d generally correspond to the memory modules 100a, 100b, 100c, 100d of the memory device 100 illustrated in FIG. 2. The transfer of signals between the memory modules 101a, 101b, 101c, 101d and between the memory device 101 and the memory controller 200 is accomplished in the same way as described above for the memory device 100. However, the memory devices 101a, 101b, 101c, 101d comprise a modified structure as to the generation of the input clock signal of the secondary receiver RxS.

In particular, the memory modules 101a, 101b, 101c, 101d each comprise a further multiplexer 160 connected to the clock signal input of the secondary receiver RxS. The multiplexer 160 receives as its input signals the related clock signal of the read data signal RD received from the next memory module of the series configuration and a regenerated clock signal from the CSU 150. Therefore, in the embodiment of memory device 101 illustrated in FIG. 4, the input clock signal of the secondary receiver RxS can be selected from the related clock signal of the read data signal RD and from the regenerated clock signal provided by the CSU 150. While the former case corresponds to the situation as illustrated in FIG. 2, in the latter case the input clock signal of the secondary receiver is generated within the memory module 101a, 101b, 101c, 101d. In this way, it is possible to provide a higher signal quality also for the input clock signal of the secondary receiver RxS. Again, the selection can be accomplished based on the signal quality of the incoming clock signals.

The memory device illustrated in FIG. 4 could also be combined with a mesosynchronous clocking arrangement as illustrated in FIG. 3, (i.e., the clock signal CLK could be provided from a PLL which is externally located with respect to the memory controller 200).

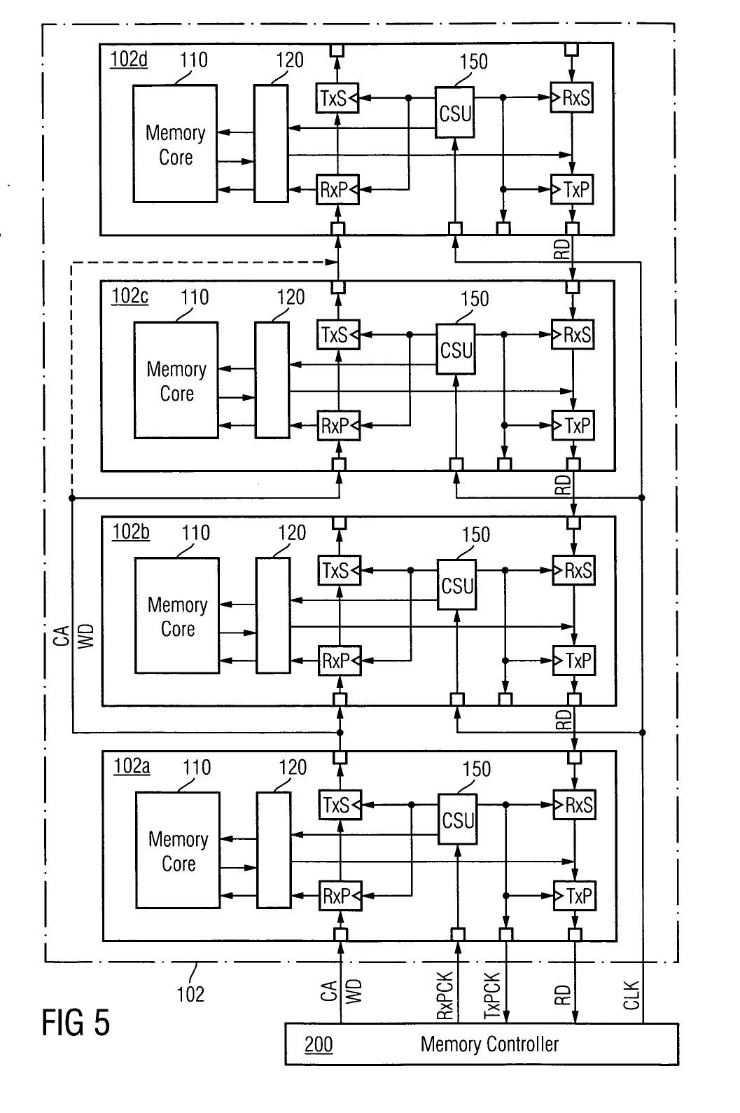

FIG. 5 illustrates one embodiment of a memory device 102 in which a plurality of memory modules 102a, 102b, 102c, and 102d are arranged in a series configuration according to the star-type architecture. The general structure of the memory device 102 corresponds to that of the memory devices 100 and 101 illustrated in FIGS. 2-4. Components corresponding to those which have already been described in connection with FIGS. 2-4 are designated with the same reference signs and further description thereof will be omitted.

As in the memory devices 100 and 101 of FIGS. 2-4, in the memory device 102, the command and write data signal CA, WD is supplied from the memory controller 200 to the first memory module 102a of the memory device. From the first memory module 102a, the command and write data signal CA, WD is transmitted to the other memory modules of the memory device 102, (i.e., to the second memory module 102b, to the third memory module 102c, and to the fourth memory module 102d). However, in case of the fourth memory module 102d, the command and write data signal is not received directly from the first memory module 102a, but via the third memory module 102c. Thus, the command and write data signal CA, WD is received in the third memory module 102c via the primary receiver RxP and then forwarded to the fourth memory module via the secondary transmitter TxS. Consequently, the distribution of the command and write data signal CA, WD in the star-type fashion is supplemented by a further distribution of the command and write data signal CA, WD on the basis of a point-to-point connection. By using this concept, it is possible to access a larger number of memory modules without increasing the number of connections in the point-to-multipoint connection.

The transmission of the read data signal RD is accomplished in the same way as described for the memory devices 100 and 101. In particular, the read data signal RD is transmitted from one memory module to the previous memory module of the series configuration until the first memory module 102a is reached. From the first memory module 102a, the read data-signal RD is transmitted to the memory controller 200.

In the memory modules 102a, 102b, 102c, and 102d of the memory device 102, the input clock signals of the primary receiver RxP, of the secondary receiver RxS of the primary transmitter TxP, and of the secondary transmitter TxS are all formed by the regenerated clock signal supplied by the CSU 150. Consequently, it is no longer required to transmit the related clock signals of the command and write data signal CA, WD and of the read data signal RD between the memory modules, as also the input clock signals of the primary receiver RxP and of the secondary receiver RxS are generated internally within the memory modules 102a, 102b, 102c, 102d. Only between the memory controller 200 and the first memory module 102a, the related clock signal RxPCK of the command and write data signal CA, WD and the related clock signal of the read data signal RD are transmitted. The related clock signal RxPCK received in the first memory module 102a forms the input clock signal of the CSU 150 of the first memory module 102a. In case of the second memory module 102b, the third memory module 102c, and the fourth memory module 102d, the input clock signal of the CSU 150 is formed by the clock signal CLK supplied by the memory controller to each of the memory modules 102b, 102c, 102d.

In the memory device 102, each of the memory modules 102a, 102b, 102c, 102d internally generates high-quality clock signals for the primary and secondary receivers RxP, RxS and for the primary and secondary transmitters TxP, TxS, thereby allowing for a reliable communication between the memory modules 102a, 102b, 102c, 102d and the memory controller 200. Further, the structure of the memory device 102 is simplified, as it is no longer required to transmit the related clock signals of the command and write data signal CA, WD and of the read data signal RD between the memory modules 102a, 102b, 102c, 102d.

The embodiment of memory device 102 illustrated in FIG. 5, could also be combined with a mesosynchronous clocking arrangement as illustrated in FIG. 3, (i.e., the clock signal CLK could be supplied from a PLL which is located externally with respect to the memory controller 200). In addition, it would be possible to distribute the command and write data signal CA, WD in the same way as in the memory devices 100 and 101, as illustrated by the dashed arrow in the signal path of the command and write data signal CA, WD.

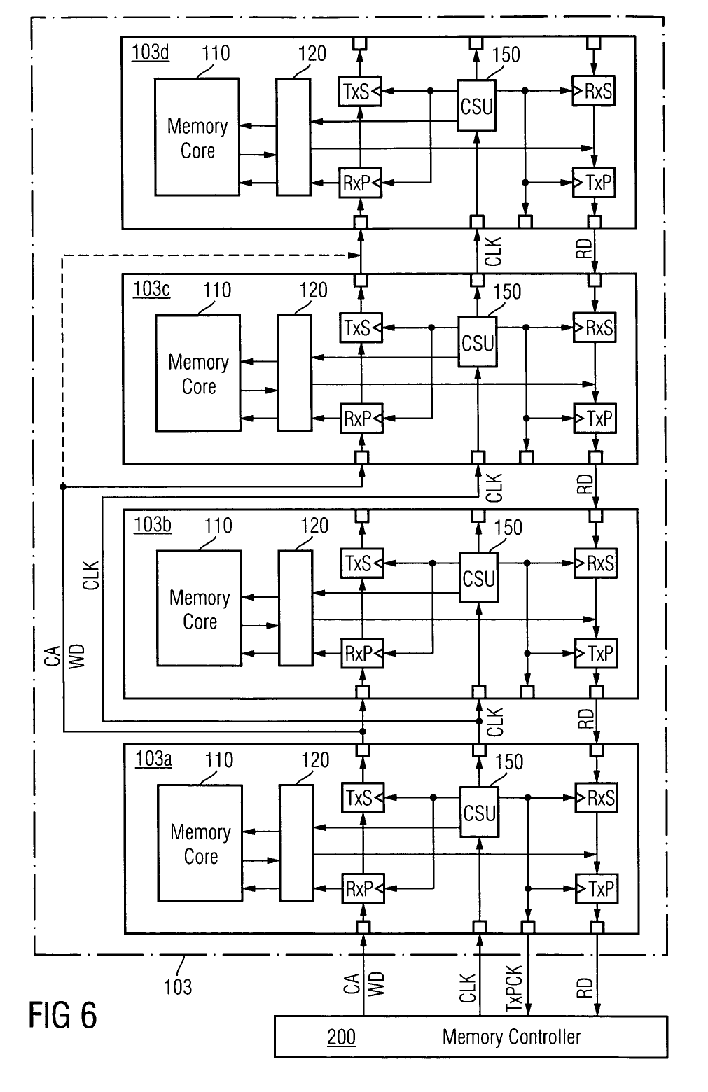

FIG. 6 illustrates one embodiment of a memory device 103 in which a plurality of memory modules 103a, 103b, 103c, and 103d are arranged in a series configuration according to the star-type architecture. The arrangement as illustrated in FIG. 6 generally corresponds to that of FIG. 5. Components corresponding to those which have already been described in connection with FIGS. 2-5 are designated with the same reference signs and further description thereof will be omitted.

In the embodiment of the memory device 103 illustrated in FIG. 6, the command and write data signal CA, WD and the read data signal RD are transmitted between the memory modules and between the memory controller 200 and the memory device 103 in the same way as described for the memory module 102 of FIG. 5. However, the distribution of the clock signal CLK to the memory modules 103a, 103b, 103c, 103d is accomplished in a different manner. In particular, the memory controller 200 supplies a clock signal CLK to the CSU 150 of the first memory module 103a. The CSU 150 produces a regenerated input clock signal which is forwarded to a corresponding signal output of the first memory module 103a. In the next memory module of the series configuration, (i.e., in the second memory module 103b, the regenerated clock signal received from the first memory module 103a is supplied as input clock signal to the CSU 150). In addition, the regenerated clock signal is transmitted from the first memory module 103a to the third memory module 103c. In the third memory module, the regenerated clock signal received from the first memory module 103a is supplied as an input clock signal to the CSU 150. The regenerated clock signal produced by the CSU 150 of the third memory module 103c is forwarded to a corresponding signal output of the third memory module 103c and from there to the fourth memory module 103d. The regenerated clock signal received in the fourth memory module 103d is used as the input clock signal of the CSU 150 of the fourth memory module.

In this way, an input clock signal can be provided to each of the memory modules 103a, 103b, 103c, 103d without having to distribute the clock signal CLK supplied by the memory controller directly to each of the memory modules. As the clock signal CLK is distributed only over short distances and regenerated in each of the memory modules, a high-quality input clock signal can be provided to each of the memory modules 103a, 103b, 103c, 103d.

As illustrated in FIG. 6, at most three of the CSUs 150 are arranged in series. This can specifically advantageous in case that the CSUs 150 of the memory modules 103a, 103b, 103c, 103d are implemented on the basis of a PLL as mentioned above. Namely, it is avoided that instabilities arise in the clock signal transmitted from one PLL to the next PLL due to higher order effects when connecting a plurality of PLL in series.

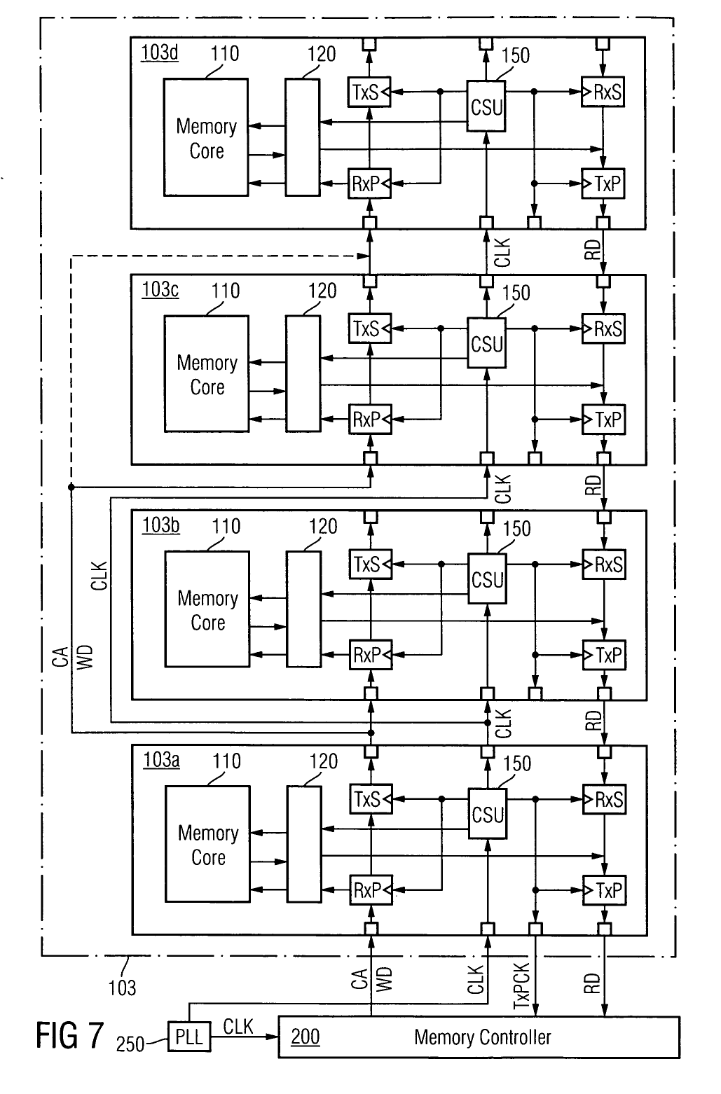

FIG. 7 illustrates one embodiment of the memory device 103 with a modified clocking arrangement of the mesosynchronous type as illustrated in FIG. 3. Generally, the arrangement as illustrated in FIG. 7 corresponds to those of FIG. 6. Components illustrated in FIG. 7 which correspond to that of FIG. 6 are designated with the same reference signs and in the following a more detailed description thereof will be omitted.

As compared to the arrangement illustrated in FIG. 6, in the arrangement of FIG. 7 the clock signal CLK is supplied to the memory device 103 from a PLL 250 which is arranged externally with respect to the memory controller 200. Further, the PLL 250 supplies the clock signal CLK to the memory controller 200. This allows for synchronizing internal clock signals of the memory controller 200 to the clock signal CLK. In particular, the command and write data signal CA, WD which is transmitted from the memory controller 200 to the memory device 103 is generated on the basis of the clock signal CLK supplied from the PLL 250.

The PLL 250 may be a separate component which is provided on the main board of a computer system and can be fully digitally implemented so as to provide the clock signal CLK with a high quality and without requiring excessive outlay.

As already mentioned above, the CSU 150 of the memory modules 100a-100d, 101a-101d, 102a-102d, 103a-103d preferably comprises a PLL for producing the regenerated clock signal. In one embodiment, the PLL is fully digitally implemented, thereby achieving a high signal quality of the regenerated clock signal without requiring an excessive amount of analog components which in some cases are difficult to integrate into the digital structure of the memory module.

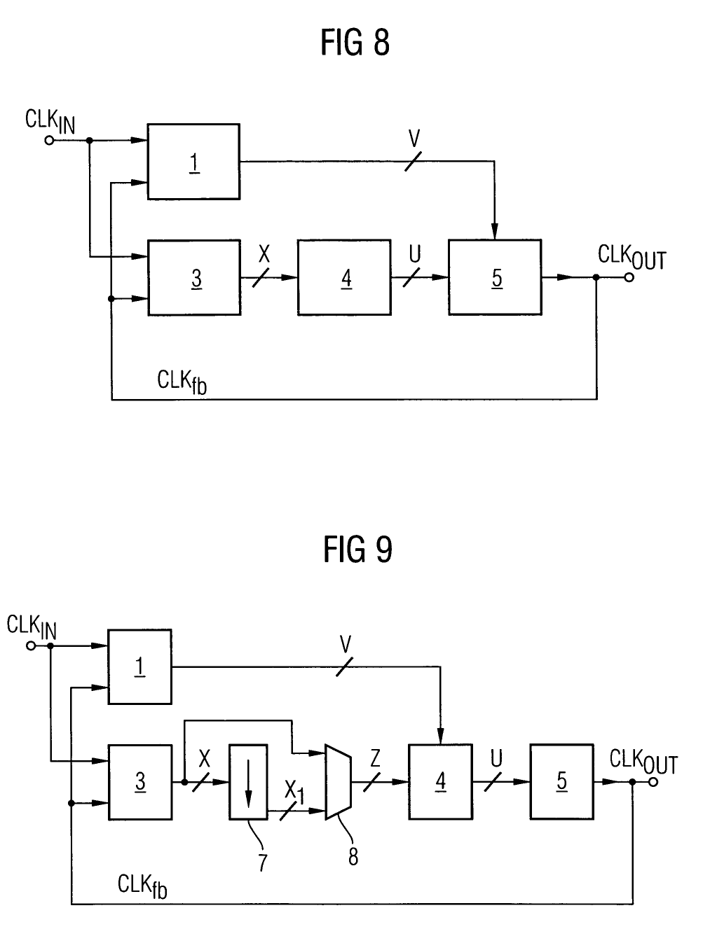

An example embodiment of a fully digitally implemented PLL to be used within the CSU 150 of the memory modules in the memory devices 100, 101, 102, 103 is illustrated in FIG. 8.

In the example embodiment of the PLL illustrated in FIG. 8, an input clock signal CLK_{IN} is supplied to a digital frequency difference detector 1 and a digital phase detector 3. Further, a feedback clock signal CLK_{fb} is supplied to the frequency detector 1 and the phase detector 3.

The frequency difference detector 1 produces a digital frequency difference signal V which represents a frequency difference between the frequency of the input clock signal CLK_{IN} and the frequency of the feedback clock signal CLK_{fb}. Correspondingly, the phase detector 3 produces a digital phase difference signal X which represents a phase difference between the input clock signal CLK_{IN} and the feedback clock signal CLK_{fb}.

The frequency difference signal V is supplied to a first control input of a digitally controlled oscillator 5.

The phase difference signal X is supplied to a digital loop filter 4, e.g. a proportional-integral-filter (PI-filter). The filtered phase difference signal U is supplied to a second control input of the digitally controlled oscillator 5. The digitally controlled oscillator 5 produces an output clock signal CLK_{OUT} having a frequency which is determined by the frequency difference signal V and the filtered phase difference signal U.

As the filtered-phase difference signal U and the frequency difference signal V are directly used for controlling the digitally controlled oscillator 5, no digital-analog-converter is necessary. Thereby, a shorter latency in the phase-locked loop and reduced noise of the output clock signal CLK_{OUT} are achieved. Generally, a very fast control of the PLL is possible.

FIG. 9 schematically illustrates another example embodiment of a PLL to be used within the CSU 150. The example PLL embodiment illustrated in FIG. 9 corresponds in many aspects to the example PLL embodiment of FIG. 8, and corresponding components have been designated with the same reference signs. In the following, only the differences as compared to the PLL of FIG. 8 are described.

In addition to the components already described to FIG. 8, the PLL of FIG. 9 comprises a decimator 7 and a multiplexer 8 which are arranged between the phase detector 3 and the digital loop filter 4, as it is illustrated in FIG. 9. The decimator 7 is supplied with the phase difference signal X and generates therefrom a decimated phase difference signal X₁. The decimated phase difference signal X₁ has, as compared to the phase difference signal X, a lower sampling rate. By means of the multiplexer 8, it can be selected whether the digital filter 4 is supplied with the phase difference signal X or with the decimated phase difference signal X₁ as a phase difference signal Z. Selection of the decimated phase difference signal Xas the phase difference signal Z is particularly useful if the frequency of the input clock signal CLK_{IN} is very large. In this case, the loop filter 4 only has to operate at a lower clock frequency which simplifies the realization. At lower frequencies of the input clock signal CLK in the phase difference signal X can be used as the phase difference signal Z.

According to a further modification with respect to FIG. 8, the frequency difference signal V is also supplied to the digital loop filter 4, and the signal U is generated in response to the phase difference signal Z and the frequency difference signal V. In this case, the digitally controlled oscillator 5 requires only one control input.

The above two modifications with respect to the phase-locked loop of FIG. 8 can be realized independently of each other.

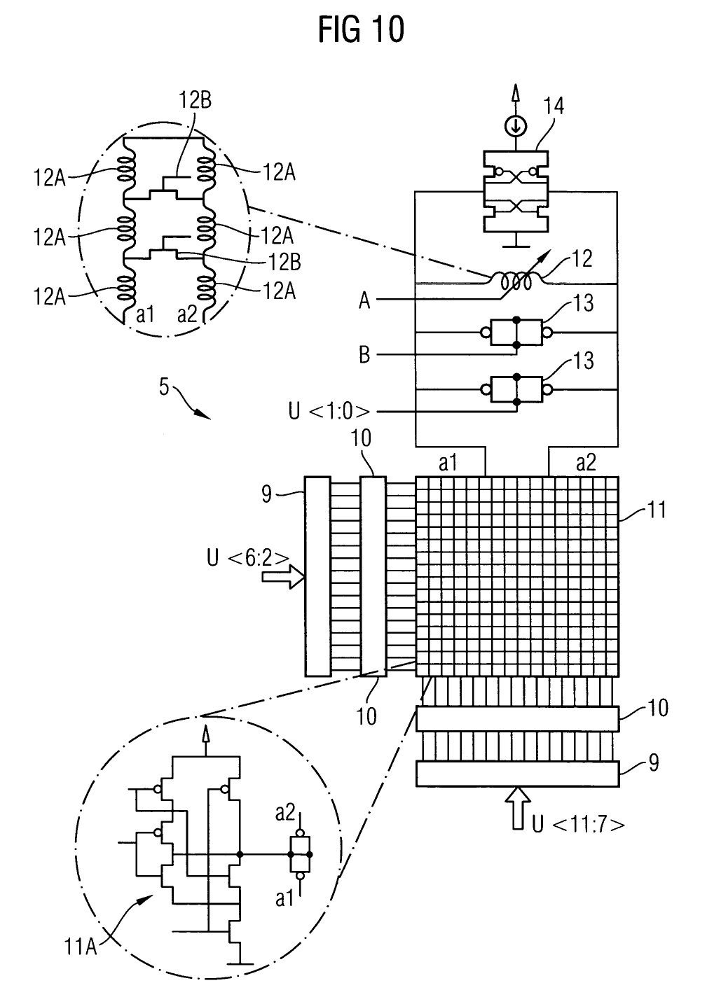

FIG. 10 illustrates schematically the structure of an embodiment of a digitally controlled oscillator 5 as used in FIG. 8 and 9. For the illustration of FIG. 10, it is assumed that a single control signal U is supplied to the digitally controlled oscillator, as described with reference to FIG. 9. By way of example, the control signal U has a width of 12 bit. In the illustrated example, the bits are enumerated from 0 to 11, 0 being the number of the bit having the lowest value and 11 being the number of the bit having the highest value.

For generating the output clock signal CLK_{OUT} there is provided a resonant circuit which essentially comprises an inductor 12 and capacitors 11 and 13. The resonant circuit is supplied from a current source 14.

In the illustrated example, bits 2 to 6 and bits 7 to 11 are each separately supplied to thermometer coders 9 which generate a thermometer code corresponding to the supplied binary code. This thermometer code is in each case stored in a latch 10 so as to compensate for differences in the signal run times within the thermometer coders 9. According to the output signal of the latches 10, a matrix 11 of varactor diodes 11A is controlled, (i.e., the varactor diodes are activated or deactivated in response to the signals provided by the latches 10), thereby changing the overall capacitance of the resonant circuit. A possible realization of the varactor diodes 11 A from transistors is illustrated in an enlarged part of FIG. 10, the outputs a1, a2 of the varactor diodes being connected to the corresponding lines a1, a2 of the resonant circuit. However, any type of switchable capacitor can be used without limitation to the structure as illustrated in FIG. 10.

The two lowermost bits 0 and 1 of the signal U are used to directly control binary weighed varactor diodes 13.

Accordingly, it is possible to modify the capacitance of the resonant circuit of the digitally controlled oscillator 5 by changing the signal U, thereby changing the frequency of the output clock signal CLK_{OUT}.

Further, initialization signals A and B can be supplied to the embodiment of the digitally controlled oscillator 5 illustrated FIG. 10. Here, the initialization signal B controls further varactor diodes 13, whereas the initialization signal A serves for controlling the inductance 12. By means of the initialization signals A and B, a frequency range can be selected in which the digitally controlled oscillator 5 operates. This can, for example, be accomplished in response to the frequency of the input clock signal CLK_{IN}.

A further enlarged part of FIG. 10 illustrates the structure of the inductor 12. In the illustrated example, the inductor 12 comprises six separate inductors 12A and two switches 12B realized from transistors, which are switched in response to the initialization signal A, thereby changing the overall inductance of the arrangement.

A fully digitally implemented PLL as described with reference to FIGS. 8 to 10 can be employed in the CSU 150 of the memory modules of the memory devices 100, 101, 102, and 103 described above. In this case, the input clock signal CLK_{IN} of the PLL is formed by the input clock signal of the CSU and the output clock signal CLK_{OUT} of the phase-locked loop forms the regenerated clock signal.

In one embodiment, as by means of the phase-locked loop the input clock signal of the CSU 150 is newly synthesized, it has a very high quality, (i.e., low noise, low jitter and a low degree of distortion).

As an alternative to the phase-locked loop, the CSU may also comprise a delay-locked loop. As compared to a phase-locked loop, a delay-locked loop does not completely newly synthesize its input clock signal. However, also a delay-locked loop may help to reduce some disturbances in the input clock signal, thereby providing an output signal which has an improved signal quality.

Further, the PLL as described in connection with FIGS. 8 to 10 may be employed as the PLL 250 for providing the clock signal CLK to the memory device 101, 102, and 103, as illustrated in FIGS. 3 and 7. In this case, the input clock signal of the PLL may be provided by a quartz oscillator and may have a lower frequency than:.the clock signal CLK, which is internally multiplied in the PLL.

In the above-described memory devices, the memory modules are can be each implemented on a single semiconductor chip. The memory modules can be combined on a printed circuit board so as to form the memory device. In one embodiment, each memory module is located on a single piece of printed circuit board, which is inserted into a respective slot of a computer system. However, it is also possible to implement two or more of the memory modules or even all of them on a single semiconductor chip.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of operating a memory device having a plurality of memory modules arranged in a series configuration, the method comprising:
receiving a command and write data signal from a memory controller in a first memory module of the series configuration;
transmitting the command and write data signal from the first memory module of the series configuration to other memory modules of the series configuration;
transmitting a read data signal from one of the memory modules of the series configuration to a previous memory module of the series configuration until the read data signal is received in the first memory module of the series configuration;
transmitting the read data signal from the first memory module of the series configuration to the memory controller;
receiving an input clock signal in each of the memory modules;
regenerating the input clock signal in a respective clock synthesizer unit of the memory module to produce a regenerated clock signal; and
synchronizing the read data signal transmitted from the memory module to the respective regenerated clock signal of the memory module.

2. The method of claim 1, comprising:
synchronizing the command and write data signal transmitted from the first memory module to the regenerated clock signal of the first memory module.

3. The method of claim 1, comprising:
generating the input clock signal of the memory modules with a phase-locked loop.

4. The method of claim 1, wherein the clock synthesizer unit of the memory modules comprises a phase-locked loop.

5. The method of claim 1, wherein the memory modules each comprise a memory core, the method comprising:
generating a clock signal for the memory core as an output signal of the clock synthesizer unit.

6. The method of claim 1, comprising:
supplying an output signal of the clock synthesizer unit of one of the memory modules as the input clock signal to at least one of the other memory modules.

7. The method of claim 1, comprising:
generating the read data signal according to data stored in a memory core of one of the memory modules.

8. A memory module configured to be arranged in a series configuration of memory modules, the memory module comprising:
a clock synthesizer unit configured to regenerating an input clock signal of the memory module and to produce a regenerated clock signal;
a first receiver configured to receive a command and write data signal from a memory controller or from another memory module located upstream in the series configuration;
a first transmitter configured to transmit a read data signal from the memory module to the memory controller or to a previous memory module of the series configuration and to synchronize the read data signal transmitted from the memory module to the regenerated clock signal of the memory module;
a second receiver configured to receive the read data signal from a next memory module of the series configuration; and
a second transmitter configured to transmit the command and write data signal to other memory modules located downstream in the series configuration and to synchronize the command and write data signal transmitted from the memory module to the regenerated clock signal of the memory module.

9. The memory module of claim 8, comprising:
a memory core configured to store data; and
wherein the clock synthesizer unit of the memory module is configured to provide a clock signal to the memory core.

10. The memory module of claim 9, wherein the clock signal provided to the memory core is phase-shifted with respect to the input clock signal of the clock synthesizer unit.

11. The memory module of claim 8, wherein the memory module is configured to generate the read data signal according to data stored in a memory core of the memory module.

12. The memory module of claim 8, wherein the clock synthesizer unit is configured to generate an input clock signal for the first receiver.

13. The memory module of claim 8, wherein the clock synthesizer unit is configured to generate an input clock signal for the second receiver.

14. The memory module of claim 8, wherein the clock synthesizer unit comprises a phase-locked loop.

15. The memory module of claim 14, wherein the phase-locked loop comprises:
a phase detector configured to generate a digital phase difference signal depending on an input clock signal of the phase-locked loop and a feedback clock signal;
a digital filter configured to receive the phase difference signal and to generate a digital filtered phase difference signal; and
a digitally controlled oscillator configured to be controlled in response to the filtered phase difference signal.

16. The memory module of claim 15, wherein the phase-locked loop comprises:
a frequency difference detector configured to generate a digital frequency difference signal depending on the input clock signal of the phase-locked loop and the feedback clock signal; and
wherein the phase-locked loop is configured to control the digitally controlled oscillator also in response to the digital frequency difference signal.

17. The memory module of claim 8, wherein the memory module is implemented on a single semiconductor chip.

18. A memory device comprising:
a plurality of memory modules arranged in a series configuration, each of the memory modules including:
a clock synthesizer unit configured to regenerate an input clock signal of the memory module and to produce a regenerated clock signal;
a first receiver configured to receiving a command and write data signal in the memory module;
a first transmitter configured to transmit a read data signal from the memory module and to synchronize the read data signal transmitted from the memory module to the regenerated clock signal of the memory module; and
a second receiver configured to receive the read data signal from a next memory module of the series configuration; and
wherein at least a first memory module of the memory device comprises a second transmitter configured to transmit the command and write data signal to other memory modules of the series configuration and to synchronize the command and write data signal transmitted from the memory module to the regenerated clock signal of the memory module.

19. The memory device of claim 18, wherein the first memory module is configured to receive the command and write data signal from a memory controller and to transmit the read data signal to the memory controller.

20. The memory device of claim 18, wherein the clock synchronizing unit of at least one of the memory modules is configured to produce the input clock signal of at least one of the other memory modules of the series configuration.

21. The memory device of claim 18, wherein each of the memory modules comprises a memory core configured to store data, and wherein the clock synthesizer unit of each memory module is configured to provide a clock signal to the memory core.

22. The memory device of claim 21, wherein the clock signal provided to the memory core is phase-shifted with respect to the input clock signal of the clock synthesizer unit.

23. The memory device of claim 18, wherein the memory modules are configured to generate the read data signal according to data stored in a memory core of the memory module.

24. The memory device of claim 18, wherein, in each of the memory modules, the clock synthesizer unit is configured to generate an input clock signal for the first receiver.

25. The memory device of claim 18, wherein, in each of the memory modules, the clock synthesizer unit is configured to generate an input clock signal for the second receiver.

26. The memory device of claim 18, wherein the clock synthesizer unit of each memory module comprises a phase-locked loop.

27. The memory device of claim 18, wherein the memory device is configured as a dynamic random access memory (DRAM) memory device.

28. A memory module configured to be arranged in a series configuration of memory modules, the memory module comprising:
means for regenerating an input clock signal of the memory module to produce a regenerated clock signal;
first means for receiving a command and write data signal from a memory controller or from another memory module located upstream in the series configuration;
first means for transmitting a read data signal from the memory module to the memory controller or to a previous memory module of the series configuration, the first means for transmitting including means for synchronizing the read data signal transmitted from the memory module to the regenerated clock signal of the memory module;
second means for receiving the read data signal from a next memory module of the series configuration; and
second means for transmitting the command and write data signal to other memory modules located downstream in the series configuration, the second means for transmitting including means for synchronizing the command and write data signal transmitted from the memory module to the regenerated clock signal of the memory module.
